(19) United States
(12) Patent Application Publication
(10) Pub. No.: US 2024/0095831 A1
(43) Pub. Date: Mar. 21, 2024

(54) CREDIT ASSISTANCE SYSTEM, CREDIT ASSISTANCE METHOD, AND PROGRAM RECORDING MEDIUM

(71) Applicant: NEC Corporation, Minato-ku, Tokyo (JP)

(72) Inventor: Tomoyuki Nishiyama, Tokyo (JP)

(73) Assignee: NEC Corporation, Minato-ku, Tokyo (JP)

(21) Appl. No.: 18/274,642

(22) PCT Filed: Mar. 29, 2021
(86) PCT No.: PCT/JP2021/013210

§ 371 Date: Jul. 27, 2023

(51) Int. Cl. G06Q 40/06

(52) U.S. Cl. CPC G06Q 40/06

(57) ABSTRACT

A credit assistance system is configured to include an extraction unit and an output unit. The extraction unit extracts a second company, financial indicators of which at a second point in time coincide with financial indicators of a first company at a first point in time later than the second point in time under prescribed conditions. The output unit outputs actual data of the financial status of the second company after the second point in time.

### TECHNICAL FIELD

The present invention relates to a technique for predicting a financial status of a company.

### BACKGROUND ART

When a financial institution conducts business activities for loans to a company, the financial institution conducts business activities to a company having a high possibility of contract depending on economic status and the financial status of the company. In addition, an examination department of a financial institution examines whether the company is appropriate as a borrower when making a loan to the company, and gives credit when the company is appropriate. However, if the person in charge selects a candidate company while determining the economic status and the financial status of the company, there is a possibility that the selected candidate company may not be appropriate for the status or may not conform to the overall strategy of the financial institution. In addition, when conducting business activities related to loans, there is a risk that the efficiency of business operations will decrease unless a credit examination is passed after preparing for a loan. Therefore, it is desirable to perform business activities targeting companies that are highly likely to accept loans and are likely to be granted credit. For example, PTL 1 discloses such a technique for predicting a candidate for a loan.

The calculation apparatus of PTL 1 calculates the degree of interest in a loan of a second business operator as a loan demand degree based on a correlation between a first business operator having a past loan record and the second business operator.

### CITATION LIST

### Patent Literature

PTL 1: JP 2018-116580 A

### SUMMARY OF INVENTION

### Technical Problem

However, the technique of PTL 1 allows the prediction of the success or failure of a loan to the second business operator, but does not allow the prediction of the financial status of the second business operator as a borrower.

In order to solve the above problems, an object of the present invention is to provide a credit assistance system that is capable of predicting a financial status from data of financial indicators of a company.

### Solution to Problem

In order to solve the above problems, a credit assistance system of the present invention includes an extraction unit and an output unit. The extraction unit extracts a second company, financial indicators of which at a second point in time coincide with financial indicators of a first company at a first point in time later than the second point in time under prescribed conditions. The output unit outputs actual data of the financial status of the second company after the second point in time.

A credit assistance method of the present invention includes extracting a second company, financial indicators of which at a second point in time coincide with financial indicators of a first company at a first point in time later than the second point in time under prescribed conditions. The credit assistance method of the present invention includes outputting actual data of the financial status of the second company after the second point in time.

A program recording medium of the present invention records a credit assistance program. The credit assistance program causes a computer to execute extracting a second company, financial indicators of which at a second point in time coincide with financial indicators of a first company at a first point in time later than the second point in time under prescribed conditions. The credit assistance program causes the computer to execute outputting performance data of the financial status of the second company after the second point in time.

### Advantageous Effects of Invention

According to the present invention, it is possible to predict a financial status of a company from data of financial indicators.

### BRIEF DESCRIPTION OF DRAWINGS

FIG. 1 is a diagram illustrating an outline of a configuration of a credit assistance system in a first example embodiment of the present invention.

FIG. 2 is a diagram illustrating an example of a configuration of the credit assistance system in the first example embodiment of the present invention.

FIG. 3 is a diagram illustrating an example of an operation flow of the credit assistance system in the first example embodiment of the present invention.

FIG. 4 is a diagram illustrating an example of a display screen in the first example embodiment of the present invention.

FIG. 5 is a diagram illustrating an example of an operation flow of the credit assistance system in the first example embodiment of the present invention.

FIG. 6 is a diagram illustrating an example of a display screen in the first example embodiment of the present invention.

FIG. 7 is a diagram illustrating an example of a display screen in the first example embodiment of the present invention.

FIG. 8 is a diagram illustrating an example of a display screen in the first example embodiment of the present invention.

FIG. 9 is a diagram illustrating an example of an operation flow of the credit assistance system in the first example embodiment of the present invention.

FIG. 10 is a diagram illustrating an example of an operation flow of the credit assistance system in the first example embodiment of the present invention.

FIG. 11 is a diagram illustrating an outline of a configuration of a credit assistance system in a second example embodiment of the present invention.

FIG. 12 is a diagram illustrating an example of an operation flow of the credit assistance system in the second example embodiment of the present invention.

FIG. 13 is a diagram illustrating an example of another configuration of the example embodiment of the present invention.

### EXAMPLE EMBODIMENTS

### First Example Embodiment

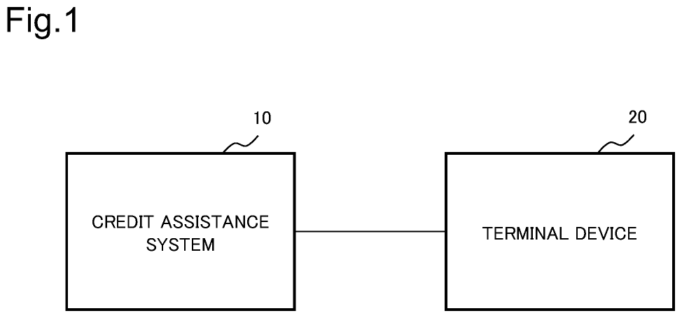

A first example embodiment of the present invention will be described in detail with reference to the drawings. FIG. 1 is a diagram illustrating an outline of a configuration of a credit assistance system according to the present example embodiment. An information processing system of the present example embodiment includes a credit assistance system 10 and a terminal device 20. The credit assistance system 10 and the terminal device 20 are connected via a network. The credit assistance system 10 includes one or a plurality of information processing apparatuses. In a case where credit assistance system 10 includes a plurality of information processing apparatuses, the information processing apparatuses are connected to each other via a network.

The information processing system in the present example embodiment is a system that predicts a company suitable as a load target and predicts the financial status of the company suitable as the target. Financial status is a status of financial growth or deterioration of a company. Financial growth means that a numerical value of a financial indicator to be desirably increased increases in corporate management, for example. Financial deterioration, financial growth means that a numerical value of a financial indicator to be desirably increased decreases in corporate management, for example.

The credit assistance system 10 in the information processing system predicts a company suitable as a load target and the financial status of the company by using a learning model generated by machine learning. The credit support system predicts a candidate suitable as a borrower by using a learning model to calculate a score indicating suitability as a borrower from data of financial indicators of a company. In the following description, a learning model that calculates a score indicating suitability as a borrower from data of financial indicators will be referred to as a score calculation model. A candidate suitable as a borrower refers to a company that is highly likely to accept a loan in response to business activities and has repayment capacity, for example. The credit assistance system calculates a growth probability of each company candidate for a borrower from data of financial indicators of the candidate company and predicts the financial status of candidate company the using the learning model. In the following description, a learning model that calculates a growth probability of a company from data of financial indicators and predicts a financial status will be referred to as a financial status prediction model.

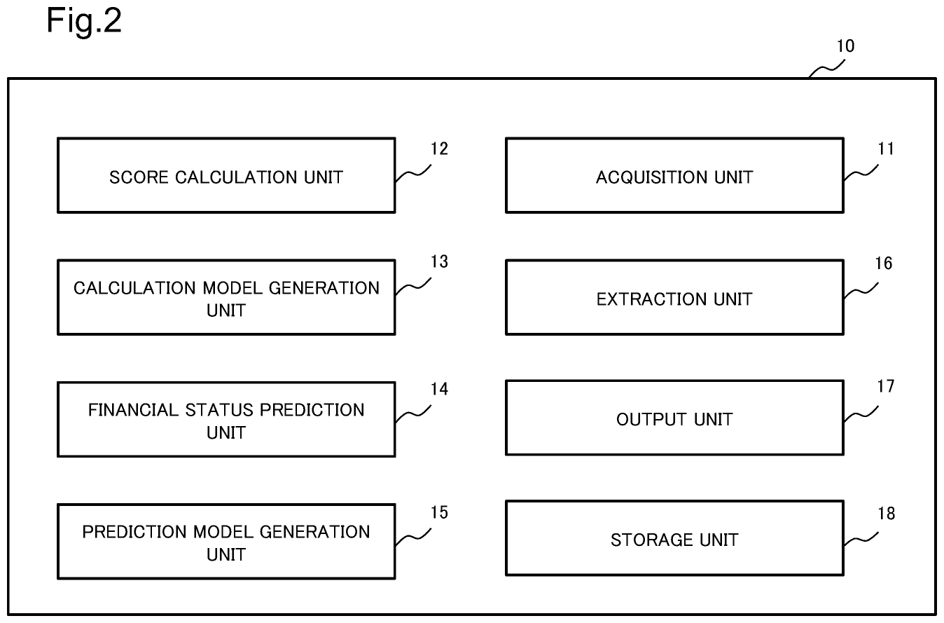

A configuration of the credit assistance system 10 will be described. FIG. 2 is a diagram illustrating an example of a configuration of the credit assistance system 10. The credit assistance system 10 includes an acquisition unit 11, a score calculation unit 12, a calculation model generation unit 13, a financial status prediction unit 14, a prediction model generation unit 15, an extraction unit 16, an output unit 17, and a storage unit 18.

The acquisition unit 11 acquires, as input data, a selection result of a loan form input by the terminal device 20 in response to an operation performed by a worker and a selection result of a company of which financial status is to be predicted. The acquisition unit 11 also acquires data of financial indicators of a company. The financial indicators are values representing performance of a company in a period, a financial state at a certain point in time, or the like. The loan form refers to a method of loan and repayment according to the use of fund in the company that is a borrower, for example. The use of the fund refers to an increase of working capital, repayment of other loans, procurement of a tax payment fund, or procurement of an acquisition fund, for example. The use of the fund is not limited to the above examples. The financial indicators to be referred to in the review of loan candidates and the credit decisions vary depending on the use of fund. Therefore, the credit assistance system 10 predicts a company suitable as a load target using the score calculation model set for each loan form.

When generating a score calculation model for predicting a company suitable as a load target, the acquisition unit 11 acquires data indicating suitability of a company for which financial indicators are used as training data in machine learning as a load target. The acquisition unit 11 acquires, from the terminal device 20, data indicating suitability as a load target, the data input to the terminal device 20 by a worker's operation. When generating a financial status prediction model for predicting the financial status of a company, the acquisition unit 11 acquires data indicating the presence or absence of growth for the company using the financial indicators as training data in machine learning. The acquisition unit 11 acquires, from the terminal device 20, data indicating the presence or absence of growth of a company that is input to the terminal device 20 by a worker's operation.

The score calculation unit 12 calculates a score indicating suitability as a load target using the score calculation model using data of financial indicators of a company as input data. The score calculation model is generated in advance by machine learning for each loan form. The score calculation unit 12 extracts data of an item set in the score calculation model as a feature amount from the data of financial indicators. With the extracted feature amount as input data, the score calculation unit 12 calculates a score indicating suitability of each company as a load target, using the score calculation model.

The calculation model generation unit 13 executes machine learning with data of financial indicators of a company as input data and suitability of a company as a loan target as a label, and generates a score calculation model for predicting a score indicating suitability of the company as a loan target from the data of financial indicators of the company.

The calculation model generation unit 13 classifies the input data of financial indicators and the suitability as a loan target as ground truth data according to a rule in a decision tree format, and performs prediction by a linear model in which different explanatory variables are combined in each case. The calculation model generation unit 13 generates a prediction model by sequentially performing optimization of a data case classification condition, generation of prediction models by optimization of a combination of explanatory variables, and deletion of an unnecessary prediction model. Such a method of generating a prediction model by machine learning is also called heterogeneous mixed learning because prediction models by a combination of different explanatory variables are combined and predicted. The score calculation model may be generated by a machine learning algorithm other than the above method as long as a company suitable as a load target can be predicted using financial indicators of the company. A heterogeneous mixed learning method is disclosed in U.S. Patent Application Publication No. 2014/0222741, for example.

The calculation model generation unit 13 may perform relearning of the score calculation model by using information on success or failure of a loan in an actually performed business activity. The calculation model generation unit 13 performs machine learning with data of financial indicators of a company as input data and data indicating suitability of a loan target reflecting performance as a label, and generates a score calculation model for calculating a score indicating suitability as a loan target from the data of financial indicators of the company. The calculation model generation unit 13 updates the data of the score calculation model stored in the storage unit 18 using the data of the score calculation model generated by relearning. By updating the score calculation model by relearning using the actual data, the accuracy of the estimation result of the company suitable as a loan target is further improved.

The financial status prediction unit 14 predicts the financial status of the target company by calculating the growth probability and deterioration probability after the current point in time, that is, after the point in time indicated by the data of financial indicators used for the prediction, using the financial status prediction model with the data of the financial indicators of the prediction target company as input data. The financial status prediction unit 14 may calculate only one of the growth probability and the deterioration probability.

For example, the financial status prediction unit 14 calculates the growth probability and deterioration probability of the prediction target company in each year from one to three years after the year indicated by the data of financial indicators used for the prediction. The prediction of the growth probability and deterioration probability may not be performed every year. The period of prediction may not be three years.

The financial status prediction unit 14 may predict the financial status by scoring the growth probability and the deterioration probability. The financial status prediction unit 14 may weight a rule used for calculating the growth probability and the deterioration probability or financial indicators included in the rule according to empirical importance, and score the calculated growth probability and deterioration probability using a preset formula. The rule is configured by a combination of a combination of feature amounts used for prediction and a condition satisfied by the combination of features.

When predicting the growth of a company, the financial status prediction unit 14 extracts a feature amount from the data of financial indicators of the prediction target company using the data of the financial status prediction model, and specifies a rule in which the extracted feature amount satisfies a set condition. The financial status prediction unit 14 selects a preset number of rules from the top among the rules in which a feature amount satisfies the condition. The financial status prediction unit 14 calculates an average value of the growth probabilities and deterioration probabilities of all the selected rules, and sets the calculated average value as the growth probability and deterioration probability of the prediction target company. Predicting the growth probability and the deterioration probability by the financial status prediction model using such a machine learning algorithm makes it possible to predict the growth of a company while grasping the grounds of prediction by rules.

The prediction model generation unit 15 generates a prediction model for predicting the growth probability of a company from current financial indicators by executing machine learning with data of past financial indicators of the company as input data and actual data of growth or deterioration as a label.

The prediction model generation unit 15 extracts data of a preset item as a feature amount from data of financial indicators of a company. The prediction model generation unit 15 calculates a combination of feature amounts and a growth probability and a deterioration probability for each condition satisfied by the combination of features, by a known method using random forest. In the growth probability and the deterioration probability, the combination of the feature amounts also includes the feature amount of only one financial indicator.

The prediction model generation unit 15 calculates the growth probability and the deterioration probability for each rule. The prediction model generation unit 15 calculates the growth probability using the ratio of the number of companies of which feature amounts satisfy the condition set by the rule, among the number of companies for which the financial indicators are used for learning. The prediction model generation unit 15 also calculates the deterioration probability using the ratio of the number of companies of which feature amounts does not satisfy the condition set by the rule, among the number of companies for which the financial indicators are used for learning.

The prediction model generation unit 15 selects and specifies, from among the generated rules by a selection algorithm, important rules in predicting the growth probability of a company. For example, the prediction model generation unit 15 makes a model that can be differentiated using the probability calculated by each rule, and selects rules using a selection algorithm that treats the model as a continuous optimization problem. The prediction model generation unit 15 ranks the selected rules such that a rule having a high degree of narrowing is placed in a high rank. The prediction model generation unit 15 stores the ranks of the rules and the data of associations among the rules in the storage unit 18, as data of the financial status prediction model. The machine learning algorithm generated in this manner is also referred to as rule discovery type inference.

The prediction model generation unit 15 may specify a categorical variable, which is an item having a high degree of influence on the presence or absence of growth of a company, among financial indicators, and a support variable, which is an item having a high degree of influence on the categorical variable, among other financial indicators, and may generate a learning model for extracting a variable having a high degree of influence on the prediction result. The degree of influence of a certain variable is the degree to which a change in the value of the variable changes the value of another variable. For example, it is assumed that a certain prediction model is generated by a machine learning algorithm and is an expression represented by a weighted linear sum of explanatory variables. In that case, the influence degree of a certain explanatory variable is a weighting factor of the explanatory variable, and is the degree to which a change in the value of the explanatory variable changes the value of an objective variable. In generating such a learning model, a set of the categorical variable and the support variable may have three layers in which a variable is further combined with the support variable as the auxiliary variable. The prediction model generation unit 15 performs prediction using a learning model generated by such a machine learning algorithm, thereby extracting a combination of explanatory variables having a high degree of influence on the presence or absence of business growth as an objective variable, so that the explanatory nature of the reason for the prediction result is enhanced.

The extraction unit 16 extracts a company of which financial indicators at a certain point in time in the past coincide with the financial indicators of a prediction target company. For example, assuming that the prediction target company is a first company and the company of which financial indicators at a certain point in time in the past coincide with the financial indicators of the first company is a second company, the extraction unit 16 extracts the second company of which financial indicators at a second point in time prescribed condition a first point in time coincide with the financial indicators of the first company at the first point in time.

For example, the extraction unit 16 specifies a company of which past financial status coincide with the past financial status of the prediction target company by using the scores indicating the financial status of the companies calculated using a preset calculation formula and the financial status of the prediction target company. Financial indicators that coincide with each other also include similar financial indicators that can be considered as coincident. For example, if a difference between a value obtained by scoring the financial indicators of the prediction target company and a value obtained by scoring the financial indicators of a company at a certain point in time in the past is equal to or less than a preset criterion, the extraction unit 16 extracts the company as a company with coincident financial indicators. That is, the extraction unit 16 extracts a company of which financial indicators at a certain point in time in the past coincide with the financial indicators of the prediction target company within a prescribed condition.

The output unit 17 outputs information on the candidate company according to the score calculated by the score calculation unit 12. The output unit 17 ranks the candidate companies in descending order of scores, and outputs the company names arranged in the ranking order and a list of scores of the companies to the terminal device 20 as display data. The output unit 17 outputs display data of a list of company names and scores up to the designated rank to the terminal device 20, for example. The output unit 17 may output display data of a list of company names with scores equal to or higher than the criterion and the scores.

The output unit 17 outputs data of the growth probability and the deterioration probability of the target company. The output unit 17 also outputs the reason for the growth prediction and the reason for the deterioration prediction of the target company. The output unit 17 also outputs the transition of the financial status of the company of which past financial status coincides with the current financial status of the target company.

The storage unit 18 stores data of the score calculation model and the financial status prediction model. The storage unit 18 stores data of financial indicators of companies.

Processing at the acquisition unit 11, the score calculation unit 12, the calculation model generation unit 13, the financial status prediction unit 14, the prediction model generation unit 15, the extraction unit 16, and the output unit 17 can be performed by executing computer programs on a central processing unit (CPU), for example. The processing at the acquisition unit 11, the score calculation unit 12, the calculation model generation unit 13, the financial status prediction unit 14, the prediction model generation unit 15, the extraction unit 16, and the output unit 17 may be performed in a plurality of information processing apparatuses connected via a network.

In the case of performing the processing in the credit assistance system 10 by a plurality of information processing apparatuses, the processing at the score calculation unit 12 and the calculation model generation unit 13 and the processing at the financial status prediction unit 14, the prediction model generation unit 15, and the extraction unit 16 may be performed by different information processing apparatuses, for example. For example, the processing of generate a learning model by machine learning at the calculation model generation unit 13 and the prediction model generation unit 15, and the processing of performing prediction using a learning model at the score calculation unit 12, the financial status prediction unit 14, and the extraction unit 16 may be performed by different information processing apparatuses. In the above configuration, the acquisition unit 11, the output unit 17, and the storage unit 18 are included in each information processing apparatus. The configuration in which the processing is performed by a plurality of information processing apparatuses is not limited to the above examples.

The storage unit 18 is configured using a hard disk drive, for example. The storage unit 18 may be configured by another type of storage device such as a nonvolatile semiconductor storage device or a combination of a plurality of types of storage devices. The storage unit 18 may be provided in a storage device connected to the credit assistance system 10. The storage unit 18 may be provided in a storage device controlled by an information processing apparatus connected via a network.

The terminal device 20 displays a list of candidate companies and display data of prediction results of financial status acquired from the credit assistance system 10 on a display device (not illustrated). The terminal device 20 also transmits, to the credit assistance system 10, a selection result of a loan form, data on suitability as a target company of a loan, data on presence or absence of growth of a company, and a selection result of a company of which a financial status is to be predicted input by the worker's operation, as input data.

An operation of the information processing system of the present example embodiment will be described.

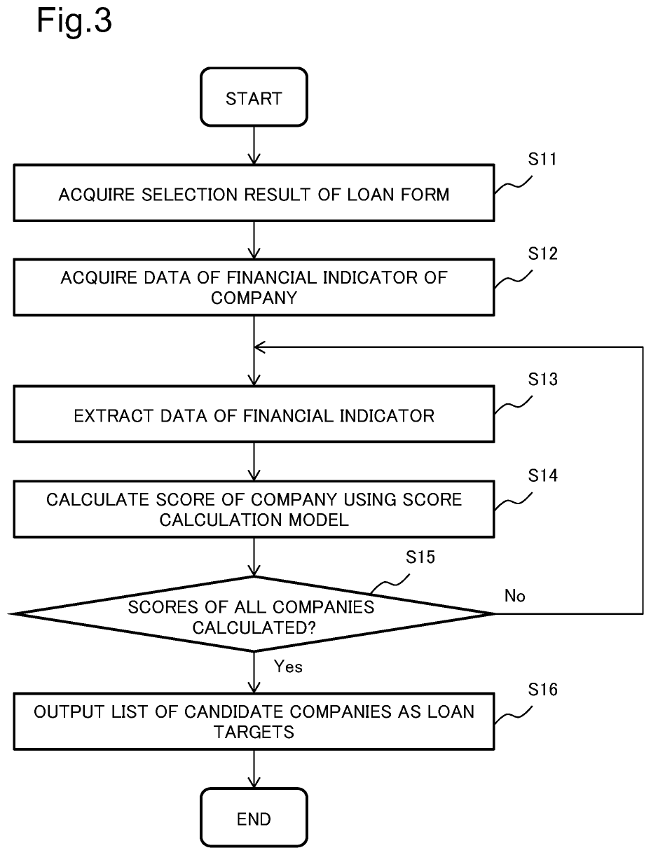

An operation of predicting suitability of a company as a loan target will be described. FIG. 3 is a diagram illustrating an example of an operation flow at the time of calculating a score indicating suitability as a loan target in the operation flow of the credit assistance system 10.

The terminal device 20 acquires data of a selection result of a loan form input by the worker's operation, as input data. The terminal device 20 transmits input data of the selection result of the loan form to the credit assistance system 10.

Referring to FIG. 3, the acquisition unit 11 acquires data of a selection result of a loan form (step S11). The acquisition unit 11 also acquires data of financial indicators of a plurality of companies (step S12). The acquisition unit 11 acquires, from the terminal device 20, data of financial indicators of a company input to the terminal device 20 by the worker's operation, for example. The acquisition unit 11 may acquire the data of financial indicators of a company from a provision server of financial information of the company connected via a network. The data of financial indicators of a company may be input to the credit assistance system 10 by the worker's operation. The acquisition unit 11 stores the acquired data of financial indicators in the storage unit 18. The company for which the data of financial indicators is to be acquired may be set according to a company or an industry type in which a financial institution is likely to conduct business activities for loans, for example.

When the data of the selection result of the loan form is acquired, the score calculation unit 12 extracts data of an item corresponding to the setting of the selected loan form as a feature amount from the data of financial indicators of the company (step S13). When extracting the data of the item set in the loan form, the score calculation unit 12 calculates a score indicating suitability as a load target using the score calculation model with the feature amount extracted from the data of the financial indicator as input data (step S14). The score calculation unit 12 calculates a score indicating suitability as a loan target by using the degree of similarity in financial indicators of the company as a positive example.

At the calculation of the score of one company, if there is a company for which the score is not calculated (No in step S15), the credit assistance system 10 repeats the processing after the extraction of the data of financial indicators in step S12 and calculates the score of the company for which the score is not calculated.

At calculation of one score, if the calculation of score has been completed for all the companies (Yes in step S15), the output unit 17 generates a list of candidate companies as loan targets in which the company names and scores are arranged in descending order of score, and outputs the list to the terminal device 20 (step S16).

Upon receiving the list of candidate companies as load targets, the terminal device 20 displays the list of candidate companies as load targets on a display device (not illustrated).

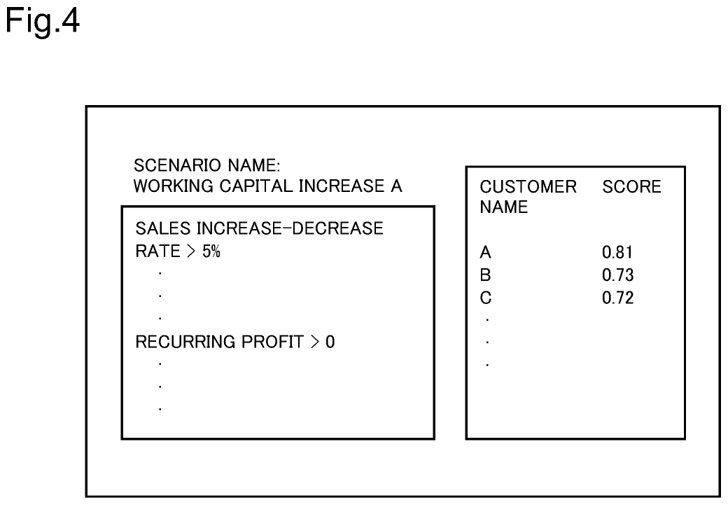

FIG. 4 is a diagram illustrating an example of a display screen of prediction results of candidate companies as load targets. Displayed on the left side of FIG. 4 are a scenario name “Working capital increase A” indicating a loan form and rules applied when the score was calculated. Displayed on the right side of FIG. 4 are customer names indicating the names of candidate companies and scores of the candidate companies in list form in order of scores. Displaying the display screen as illustrated in FIG. 4 allows the worker to obtain information on a company having high suitability as a loan target while referring to the rules at the time of prediction. In the example of FIG. 4, the applied rules may be configured to be rewritable by the worker's operation. If the applied rules are rewritable, the acquisition unit 11 acquires a rule change result input to the terminal device 20 by the worker's operation as input data. The calculation model generation unit 13 updates the data of the score calculation model using the acquired input data.

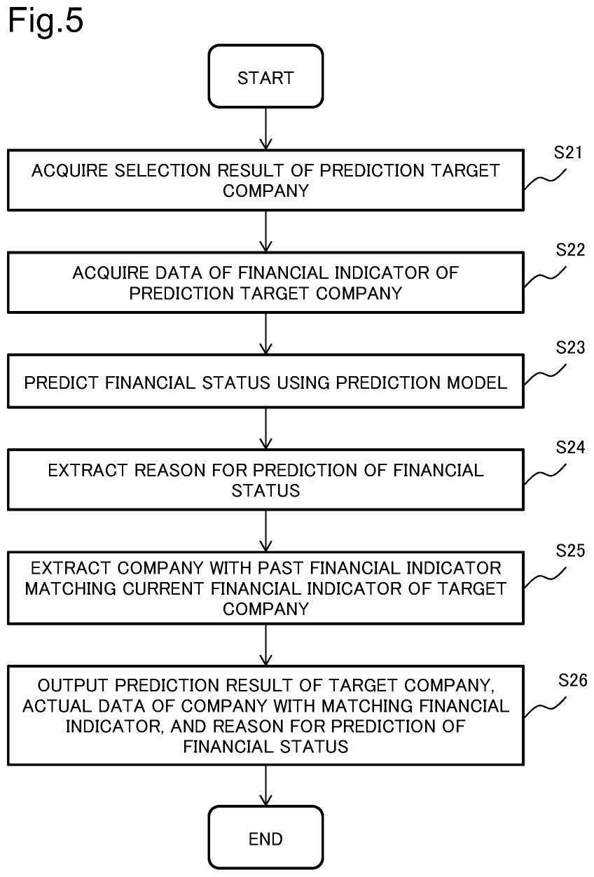

An operation of predicting a financial status of a company will be described. FIG. 5 is a diagram illustrating an example of an operation flow of predicting a financial status of a company among operation flows of the credit assistance system.

The terminal device 20 acquires, as input data, a selection result of a prediction target company of the financial status input by the worker's operation. The terminal device 20 transmits the input data of the selection result of the prediction target company to the credit assistance system 10. The selection of the prediction target company of the financial status is performed by clicking the name part of a candidate company by the worker operating the mouse on the display screen of the list of candidate companies as loan targets in FIG. 4, for example.

Referring to FIG. 5, the acquisition unit 11 acquires the selection result of the target company of which the financial status is to be predicted from the terminal device 20 (step S21). Upon acquiring the selection result of the prediction target company, the acquisition unit 11 acquires data of financial indicators of the selected company (step S22). The acquisition unit 11 stores the acquired data of financial indicators of the company in the storage unit 18. If the selected financial indicators of the company are stored in the storage unit 18, the acquisition unit 11 is not required to newly acquire the data of financial indicators.

When the data of financial indicators is acquired, the financial status prediction unit 14 predicts the financial status of the prediction target company using a financial status prediction model with the data of financial indicators as input data (step S23). The financial status prediction unit 14 calculates the financial status as a growth probability. At the prediction of the financial status, the financial status prediction unit 14 extracts a preset number of prediction rules in descending order of probability from among the prediction rules to which the conditions apply. The financial status prediction unit 14 calculates the growth probability of the target company by calculating the average value of the growth probabilities for the extracted prediction rules. The financial status prediction unit 14 calculates the deterioration probability of the target company by calculating the average value of the deterioration probabilities for the extracted prediction rules.

After calculating the growth probability and the deterioration probability, the financial status prediction unit 14 extracts the conditions indicated by the rules used for calculating the growth probability and the deterioration probability as the reason for prediction (step S24).

The extraction unit 16 extracts a company having a high degree of similarity between the financial indicators at a past point in time and the current financial indicators of the prediction target company as a company having coincident financial indicators (step S25). The extraction unit 16 calculates the scores of financial indicators using a preset calculation formula, for example, and extracts a company having a high similarity as a company having coincident financial indicators using the calculated scores. The extraction unit 16 may specify a company that is included a large number of times in the extracted prediction rules as a company having financial indicators coincident with those of the prediction target company.

When the prediction of the financial status and the extraction of a similar company with coincident past financial status are performed, the output unit 17 generates display data of the prediction result of the financial status and outputs the display data to the terminal device 20. The output unit 17 outputs the prediction result of the financial status of the prediction target company, the actual data of the company with coincident financial indicators, and the reason for prediction of the financial status to the terminal device as the prediction result (step S26). Upon acquiring the display data of the prediction result, the terminal device 20 displays the prediction result on a display device (not illustrated) using the display data.

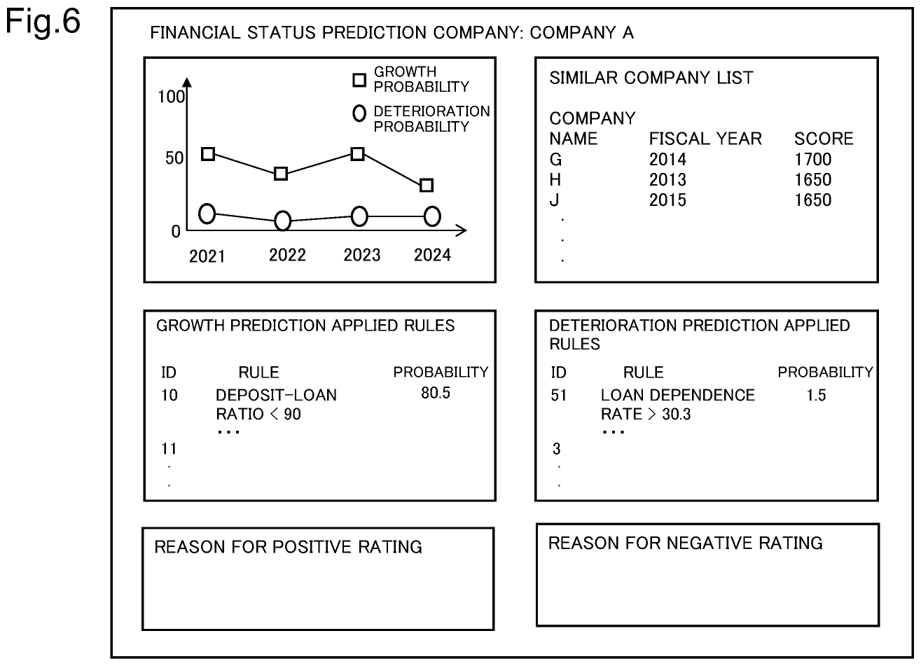

FIG. 6 is a diagram illustrating an example of a display screen of prediction results of a financial status. In the upper left of FIG. 6, the company name of the prediction target company is displayed in the column of financial status prediction company. In the example of FIG. 6, company A is displayed as a prediction target company. Under the name “financial prediction target company” in FIG. 6, the prediction results of the financial status of the prediction target company are shown as a growth probability and a deterioration probability. On the right side in the upper part of FIG. 6, the names of companies with coincident past financial indicators are displayed in a similar company list. The similar company list includes the names of companies with coincident financial indicators, years with coincident financial indicators, and scores indicating the degree of similarity.

In the middle part of FIG. 6, growth prediction applied rules that were used for calculating the growth probability and deterioration prediction applied rules that were used for calculating the deterioration probability are displayed. The column of growth prediction applied rules includes IDs indicating the identifications of the rules, the contents of the rules, and the probabilities under the rules. The rule with ID of 10 includes a condition that the indicator of the cash deposit-loan ratio is 90 or less, and the growth probability indicated under the rule with ID of 10 is 80.5 percent. The column of deterioration prediction applied rules includes IDs indicating the identifications of the rules, the contents of the rules, and the probabilities under the rules. The rule with ID of 51 includes a condition that the loan dependence rate is greater than 30.3, and the growth probability indicated by the rule with ID of 51 is 1.5 percent. Only one of the growth prediction applied rules and the deterioration prediction applied rules may be displayed.

In the lower part of FIG. 6, the reason for the growth prediction and the reason for the deterioration prediction are shown as a reason for positive evaluation and a reason for negative evaluation. The reason for positive evaluation is output as a natural sentence generated using a rule having a high probability among the growth prediction applied rules. The correspondence between the items included in the rule and the generated natural sentence is set in advance. The correspondence between the item included in the rule and the generated natural sentence may be determined using a learning model generated by machine learning. The reason for negative evaluation is output as a natural sentence generated using a rule having a high probability among the deterioration prediction applied rules. The correspondence between the items included in the rule and the generated natural sentence is set in advance. Only one of the reason for positive evaluation and the reason for negative evaluation may be displayed.

By referring to the prediction results as illustrated in FIG. 6, a person involved in a business activity of a loan or a credit inspector who decides whether to extend a loan to a company can use the prediction results to determine the financial status of the company while determining the validity of the prediction results using the reason for prediction.

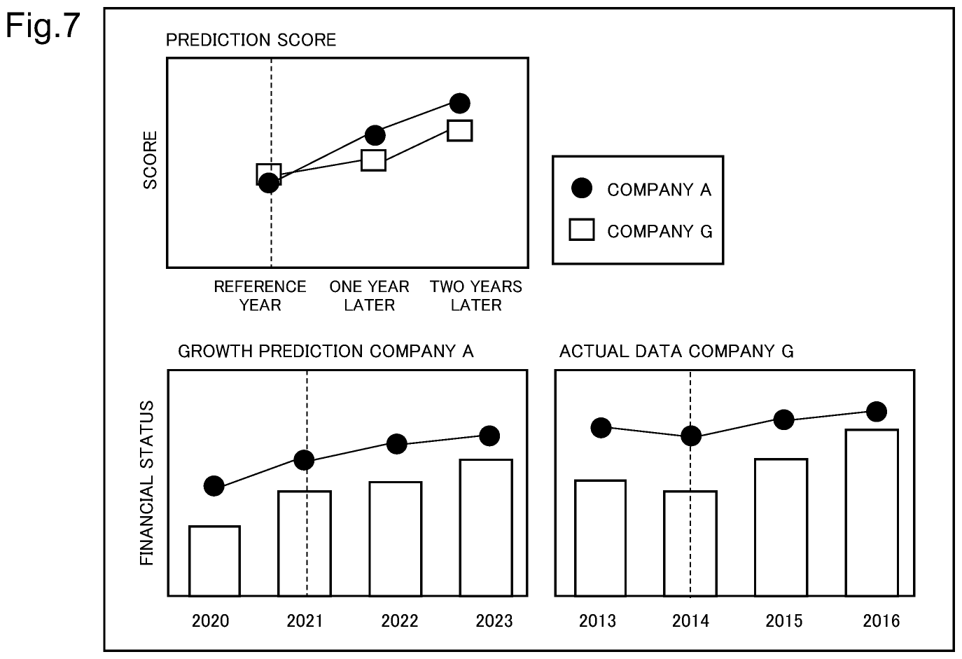

FIG. 7 is a diagram illustrating an example of a prediction result display screen in a case where a similar company is selected in FIG. 6. In FIG. 7, a company G is selected because the degree of similarity between the financial indicators of company G in 2014 and the financial indicators of the prediction target company is high and the financial indicators coincide with each other. The selection of a company having coincident financial indicators is performed by clicking the name part of the similar company by the worker's mouse operation on the display screen of a similar company list in FIG. 6, for example. The selection of a company having coincident financial indicators may be performed by automatically selecting a company having the highest degree of similarity in financial use.

The graph of the upper part of FIG. 7 shows, in a graph form, values obtained by scoring the growth probabilities of company A predicted by the financial status prediction model using a predetermined calculation formula and values obtained by scoring the actual data of company G. The vertical axis in FIG. 7 indicates the magnitude of the score value. The reference year of company A is the current year, and the reference year of company G is 2014 when the financial indicators of company G coincide with the financial indicators of company A. In this way, by displaying the years in which the financial indicators coincide with each other, it is possible to compare the prediction results with the actual data and easily confirm the validity of the prediction results.

The left side of the lower part of FIG. 7 shows the financial status of company A which is the prediction target company, and the right side shows the financial status of company G having similar financial indicators. Out of the lower graphs of FIG. 7, the bar graph indicates sales, for example, and the line graph indicates current profit, for example. The vertical axes of the lower graphs of FIG. 7 are set to indicate the amount of money or the standardized amount of money, for example. The output unit 17 provides display such that the financial status of company A in 2021, which is the current financial status, and the financial status of company G in 2014 coincide with each other in the positions in the graphs.

In the graph of the growth prediction of company A in FIG. 7, the data in 2020 and 2021 is the actual data, and the data in 2022 and 2023 is predicted values. The future growth prediction of company A is calculated using statistical values of amounts of change of a similar company, for example. The future growth prediction of company A may be performed by a prediction method using a linear model. As the data of company A, only past and current data may be displayed. As illustrated in FIG. 7, by displaying the actual state and the predicted values of the prediction target company and the actual data of the company having similar past financial indicators side by side, the worker using the prediction results can make a determination using the prediction results while confirming the validity of the prediction results.

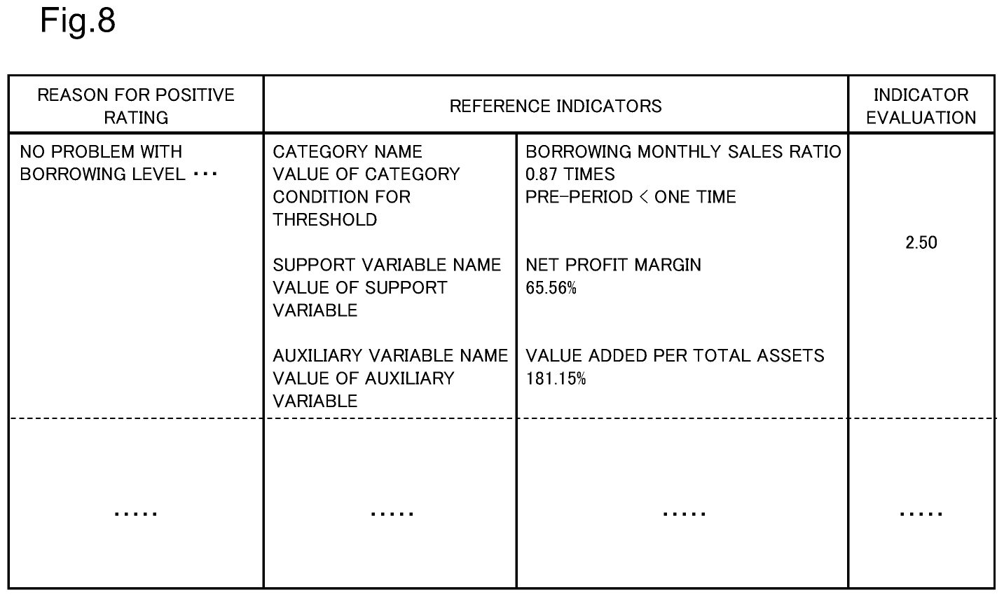

FIG. 8 is a diagram illustrating an example of a display screen displaying the reasons for prediction in FIG. 6 in more detail. In FIG. 8, a category, a support variable, and an auxiliary variable are displayed in one set as a reference indicator. In the column of reference indicator, item names and values of variables having a large influence on the prediction results are displayed. The reason for positive evaluation is displayed as an explanatory sentence generated using the data of the reference indicator. The indicator evaluation is displayed as an indicator of the influence of the reference indicator calculated by a preset method on the prediction results.

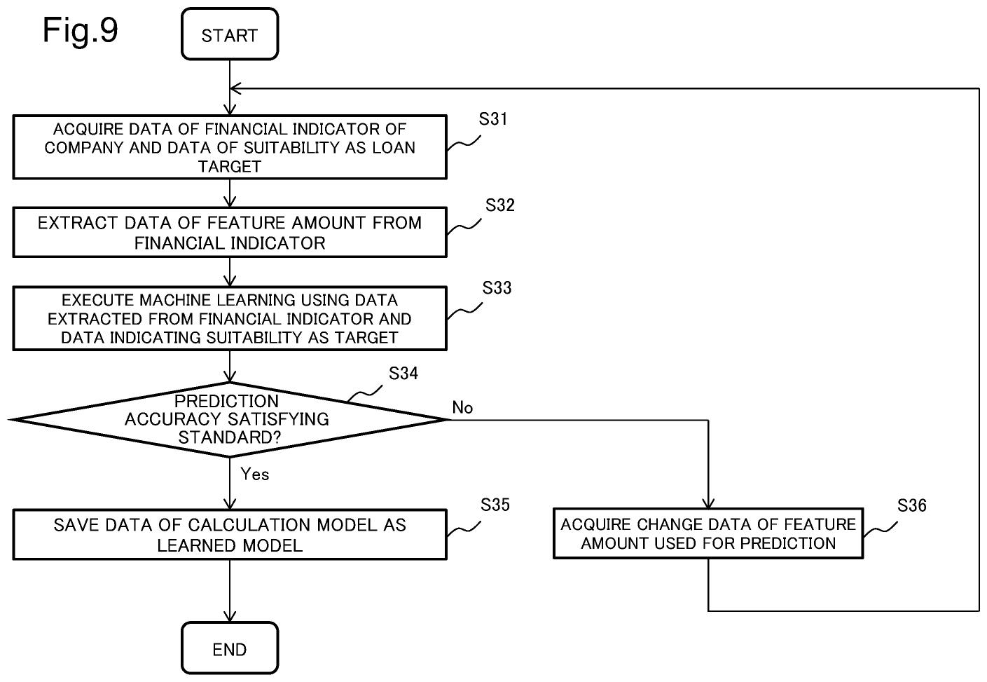

The operation of generating a score calculation model will be described. FIG. 9 is a diagram illustrating an example of an operation flow of the credit assistance system 10 in generating a score calculation model.

The terminal device 20 acquires, as input data, data indicating suitability as a target of a business activity input by the worker's operation. The terminal device 20 transmits input data indicating suitability as a target of business activity to the credit assistance system 10.

In FIG. 9, the acquisition unit 11 acquires data of financial indicators of a company and data indicating suitability as a loan target (step S31). The acquisition unit 11 acquires, from the terminal device 20, data input to the terminal device 20 by the worker's operation, for example. The acquisition unit 11 may acquire data of financial indicators of a company from a server of a financial information providing service via a network.

When the data of financial indicators of a company is acquired, the calculation model generation unit 13 extracts data of an item to be used for generating a score calculation model as a feature amount from the data of financial indicators (step S32). The items of the financial indicators to be extracted as the feature amount are input to the terminal device 20 by an expert of credit examination or an operator who has received an instruction from the expert, for example, and are acquired from the terminal device 20 by the acquisition unit 11.

After extracting the feature amount to be used for generating the score calculation model, the calculation model generation unit 13 performs machine learning with the feature amount extracted from the data of financial indicators of a company as input data and with a data indicating suitability of the company as a business target as a label (step S33). The calculation model generation unit 13 generates a score calculation model that outputs a score indicating suitability as a target of business activity from the data of financial indicators of the company by machine learning. The score calculation model is generated for each loan form. The score calculation model includes items extracted as feature amounts from financial indicators and data including score calculation rules. The score calculation model is generated by machine learning using a linear model, for example. The score calculation model may be generated by machine learning using a heterogeneous mixed learning method.

After generating the score calculation model, the calculation model generation unit 13 verifies the accuracy of the score calculation model using the test data. When the accuracy of the generated score calculation model satisfies a preset criterion (Yes in step S34), the calculation model generation unit 13 stores the data of the generated score calculation model in the storage unit 18 as the data of the learned model (step S35).

When the accuracy of the generated score calculation model does not satisfy the preset criterion (No in step S34), the acquisition unit 11 acquires the change data of the item of the feature amount used for prediction of the score (step S36). The acquisition unit 11 acquires, from the terminal device 20, the change data of the item of the feature amount used for prediction of the score input to the terminal device 20 by the worker's operation.

Upon acquiring the change data of the feature amount, the credit assistance system 10 returns to step 31, and repeats operations subsequent to the process of acquiring the data of financial indicators of the company by the acquisition unit 11 and the data indicating suitability as a target of business activities.

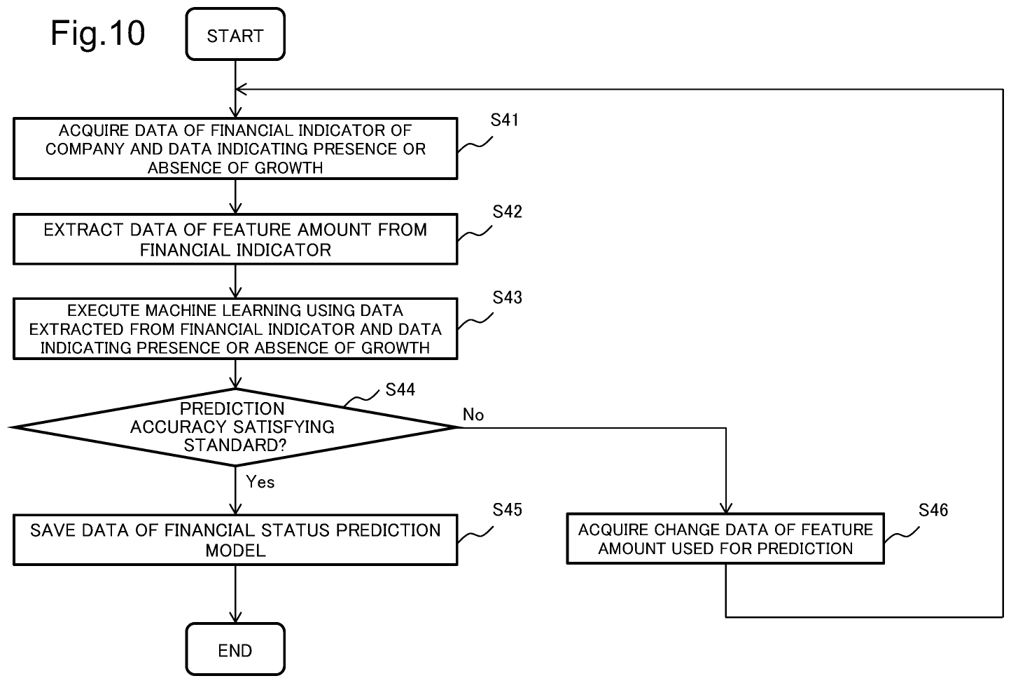

An operation of generating the financial status prediction model will be described. FIG. 10 is a diagram illustrating an example of an operation flow of the credit assistance system 10 at the generation of a financial status prediction model.

The terminal device 20 acquire data indicating the presence or absence of growth of a company input by the worker's operation, as input data. The terminal device 20 transmits the input data indicating the presence or absence of growth of a company to the credit assistance system 10.

In FIG. 10, the acquisition unit 11 acquires data of financial indicators of a company and data indicating the presence or absence of growth (step S41). The acquisition unit 11 acquires the data indicating the presence or absence of growth of a company from the terminal device 20. The acquisition unit 11 acquires, from the terminal device 20, data of financial indicators of a company input to the terminal device 20 by the worker's operation, for example. The acquisition unit 11 may acquire the data of financial indicators of a company from a provision server of financial information of the company connected via a network. The data of financial indicators of a company may be input to the credit assistance system 10 by the worker's operation. The acquisition unit 11 stores the acquired data of financial indicators in the storage unit 18.

When the data of financial indicators of the company and the data indicating the presence or absence of growth are acquired, the prediction model generation unit 15 extracts data of a preset item from the data of financial indicators as a feature amount (step S42). The items of the financial indicators to be extracted as the feature amount are input to the terminal device 20 by an expert of company finance or an operator who has received an instruction from the expert, for example, and are acquired from the terminal device 20 by the acquisition unit 11.

After generating the feature amount, the prediction model generation unit 15 executes machine learning with the feature amount as input data and data indicating presence or absence of growth as a label (step S43). The prediction model generation unit 15 generates a financial status prediction model for predicting the presence or absence of growth of a company from the data of feature amount extracted from financial indicators.

After generating the financial status prediction model, the prediction model generation unit 15 verifies the accuracy of the financial status prediction model using test data. When the accuracy of the generated financial status prediction model satisfies a preset criterion (Yes in step S44), the prediction model generation unit 15 stores data of the generated financial status prediction model in the storage unit 18 as data of the learned model (step S45).

When the accuracy of the generated financial status prediction model does not satisfy the preset criterion (No in step S44), the acquisition unit 11 acquires the change data of the item of the feature amount used for the prediction of the financial status (step S46). The acquisition unit 11 acquires, from the terminal device 20, the change data of the item of the feature amount used for prediction of the financial status input to the terminal device 20 by the worker's operation.

Upon acquiring the change data of the feature amount, the credit assistance system 10 returns to step 41, and repeats operations subsequent to the process of acquiring the data of financial indicators of the company by the acquisition unit 11 and the data indicating suitability as a loan target.

The credit assistance system according to the present example embodiment calculates, for each loan form, a score indicating suitability of a company as a loan target from data of financial indicators of the company, using a score calculation model generated with presence or absence of suitability of the loan target as a label. In addition, the credit assistance system according to the present example embodiment generates a list of companies having high suitability as loan targets by using the calculated scores. By referring to the list of companies with high suitability as loan targets and approaching companies with high scores, the possibility of acceptance of a loan is increased, and the possibility of rejection in a credit examination is reduced, thereby improving the efficiency of business activities for loans.

The credit assistance system 10 in the information processing system according to the present example embodiment predicts the growth probability of a company selected as a prediction target company from the data of financial indicators of the prediction target company, using a financial status prediction model generated with the data of financial indicators of a company as input data and the presence or absence of growth as a label. The credit assistance system 10 according to the present example embodiment outputs an explanation of the reason for prediction by using financial indicators having a large influence on the prediction results of the growth probability. Outputting the reason for prediction together with the prediction results makes it possible to utilize the prediction results while confirming the validity of the prediction results.

The credit assistance system 10 outputs performance data of the financial status of a company of which financial status coincide with the past financial status of the prediction target company. Outputting the actual data of the company with coincident financial status and the data of the prediction target company in a comparable state makes it easier to recognize the future financial status of the target company. Therefore, the credit assistance system 10 of the information processing system in the present example embodiment can predict the financial status of a prediction target company from the data of financial indicators of the company.

### Second Example Embodiment

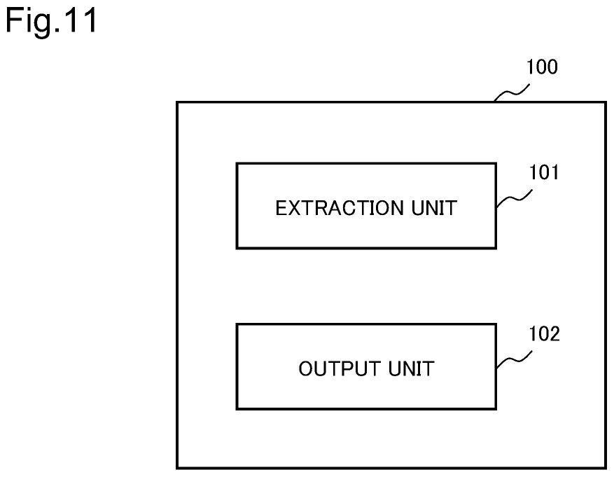

A second example embodiment of the present invention will be described in detail with reference to the drawings. FIG. 11 is a diagram illustrating an example of a configuration of a credit assistance system 100 according to the present example embodiment. The credit assistance system 100 according to the present example embodiment includes an extraction unit 101 and an output unit 102. The extraction unit 101 extracts a second company, financial indicators of which at a second point in time coincide with financial indicators of a first company at a first point in time later than the second point in time under prescribed conditions. The output unit 102 outputs actual data of the financial status of the second company after the second point in time.

The extraction unit 16 of the first example embodiment is an example of the extraction unit 101. The extraction unit 101 is an aspect of an extraction means. The output unit 17 of the first example embodiment is an example of the output unit 102. The output unit 102 is an aspect of an output means.

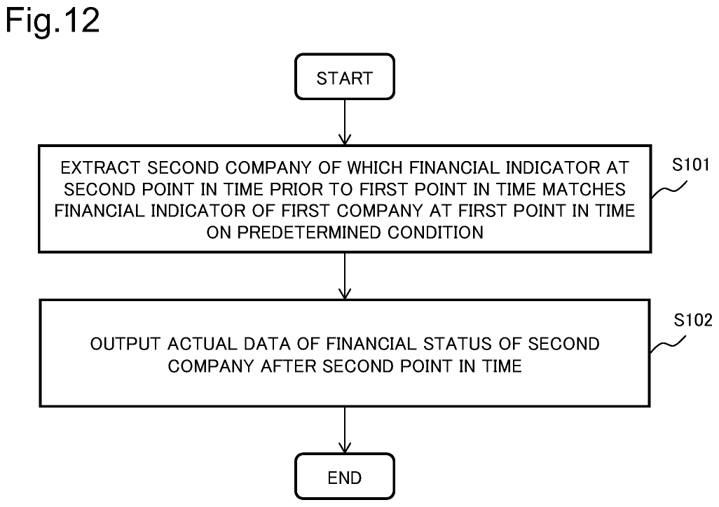

Operations of the credit assistance system 100 will be described. FIG. 12 is a diagram illustrating an example of an operation flow of the credit assistance system 100. The extraction unit 101 extracts a second company, financial indicators of which at a second point in time coincide with financial indicators of a first company at a first point in time later than the second point in time under prescribed conditions (step S101). Upon extracting the second company, the output unit 102 outputs actual data of the financial status of the second company after the second point in time (step S102).

The credit assistance system 100 of the present example embodiment outputs the actual data of status of the second company of which the financial indicators coincide with the financial indicators of the first company at a second starting point before the first point in time under prescribed conditions. Therefore, with the use of the credit assistance system 100 of the present example embodiment, it is possible to predict the financial status of the first company by referring to past actual data of financial indicators of the second company similar to the financial indicators of the first company.

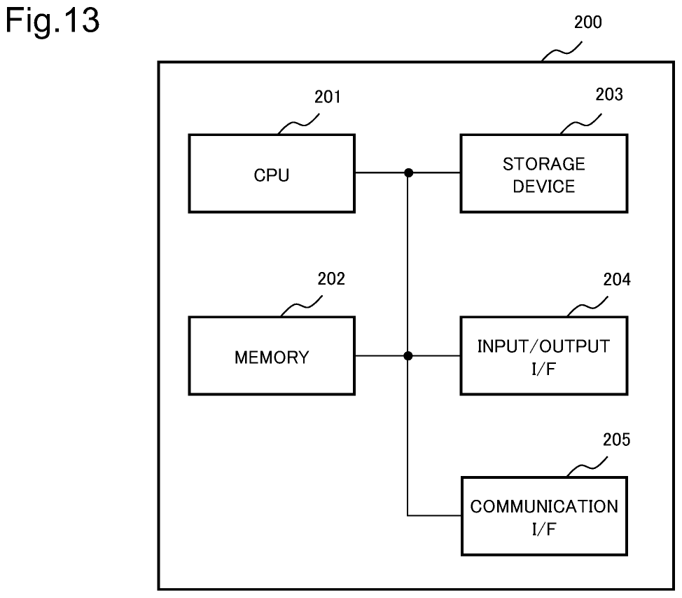

The processing in the credit assistance system 10 of the first example embodiment and the credit assistance system 100 of the second example embodiment can be performed by executing a computer program on a computer. FIG. 13 illustrates an example of a configuration of a computer 200 that executes the computer program for performing the processing in the credit assistance system 10 of the first example embodiment and the credit assistance system 100 of the second example embodiment. The computer 200 includes a CPU 201, a memory 202, a storage device 203, an input/output interface (I/F) 204, and a communication I/F 205.

The CPU 201 reads and executes the computer program for performing the processing from the storage device 203. The CPU 201 may be formed by a combination of a CPU and a graphics processing unit (GPU). The memory 202 includes a dynamic random access memory (DRAM) or the like, and temporarily stores the computer program executed by the CPU 201 and data being processed. The storage device 203 stores the computer program executed by the CPU 201. The storage device 203 includes a nonvolatile semiconductor storage device, for example. As the storage device 203, another storage device such as a hard disk drive may be used. The input/output I/F 204 is an interface that receives an input from the worker and outputs display data and the like. The communication I/F 205 is an interface that transmits and receives data to and from the terminal device 20. The terminal device 20 can have a similar configuration.

The computer program used for executing the processing can also be stored in a recording medium and distributed. As the recording medium, a magnetic tape for data recording or a magnetic disc such as a hard disc can be used, for example. As the recording medium, an optical disc such as a compact disc read only memory (CD-ROM) can also be used. A non-volatile semiconductor storage device may be used as a recording medium.

Some or all of the above example embodiments may be described as in the following Supplementary Notes, but are not limited to the following notes.

[Supplementary Note 1]

A credit assistance system including:
an extraction means that extracts a second company of which a financial indicator at a second point in time coincides with a financial indicator of a first company at a first point in time later than the second point in time under a prescribed condition; and
an output means that outputs actual data of financial status of the second company after the second point in time.

[Supplementary Note 2]

The credit assistance system according to Supplementary Note 1, further including a prediction means that predicts a financial status of the first company after the first point in time from the financial indicator of the first company at the first point in time by using a prediction model that has learned a relationship between data of a financial indicator of a company and data indicating a growth or deterioration status of the company, wherein
the output means outputs the financial status of the first company after the first point in time predicted by the prediction means and the actual data of the financial status of the second company after the second point in time.

[Supplementary Note 3]

The credit assistance system according to Supplementary Note 2, wherein the output means outputs a financial indicator having a higher degree of influence on a prediction result of the financial status of the first company after the first point in time than other financial indicators.

[Supplementary Note 4]

The credit assistance system according to Supplementary Note 3, wherein the prediction means specifies a first financial indicator having a higher degree of influence on the prediction result than other financial indicators and a second financial indicator having a higher degree of influence on the first financial indicator than other financial indicators, and
the output means outputs the first financial indicator and the second financial indicator.

[Supplementary Note 5]

The credit assistance system according to Supplementary Note 4, wherein the output means outputs an explanatory sentence of the prediction result based on the first financial indicator and the second financial indicator specified by the prediction means.

[Supplementary Note 6]

The credit assistance system according to any one of notes 2 to 5, further including a prediction model generation means that generates the prediction model by machine learning.

[Supplementary Note 7]

The credit assistance system according to any one of Supplementary Notes 2 to 6, further including a score calculation means that calculates a score indicating suitability as a loan target from a financial indicator of a company, by using a score calculation model having learned a relationship between data of a financial indicator of a company and data indicating suitability of the company as a loan target, wherein
the output means outputs a list of companies of which the score satisfies a predetermined criterion, and
the prediction means predicts the financial status of the first company after the first point in time, regarding a company included in the list as the first company.

[Supplementary Note 8]

The credit assistance system according to Supplementary Note 7, wherein the output means outputs an item of a feature amount of the score calculation model used for calculation of the score and information of a weight of the feature amount, and
the score calculation means calculates the score by using the score calculation model reflecting the item of the feature amount and a changed value of the weight of the feature amount.

[Supplementary Note 9]

The credit assistance system according to Supplementary Note 7 or 8, wherein the score calculation means calculates the score by using the score calculation model according to a form of loan to the company, and
the output means outputs the list according to the form of the loan.

[Supplementary Note 10]

The credit assistance system according to any one of Supplementary Notes 7 to 9, further including a calculation model generation means that generates the score calculation model and update the score calculation model by retraining using the data indicating suitability of the company as a loan target, the data being set based on the presence or absence of fulfillment of a loan to the company.

[Supplementary Note 11]

A credit assistance method including: extracting a second company of which a financial indicator at a second point in time coincides with a financial indicator of a first company at a first point in time later than the second point in time under a prescribed condition; and
outputting actual data of financial status of the second company after the second point in time.

[Supplementary Note 12]

The credit assistance method according to Supplementary Note 11, further including: predicting a financial status of the first company after the first point in time from the financial indicator of the first company at the first point in time by using a prediction model that has learned a relationship between data of a financial indicator of a company and data indicating a growth or deterioration status of the company; and
outputting the predicted financial status of the first company after the first point in time and the actual data of the financial status of the second company after the second point in time.

[Supplementary Note 13]

The credit assistance method according to Supplementary Note 12, further including outputting a financial indicator having a higher degree of influence on a prediction result of the financial status of the first company after the first point in time than other financial indicators.

[Supplementary Note 14]

The credit assistance method according to Supplementary Note 13, further including: specifying a first financial indicator having a higher degree of influence on the prediction result than other financial indicators and a second financial indicator having a higher degree of influence on the first financial indicator than other financial indicators; and
outputting the first financial indicator and the second financial indicator.

[Supplementary Note 15]

The credit assistance method according to Supplementary Note 14, further including outputting an explanatory sentence of the prediction result based on the specified first financial indicator and second financial indicator.

[Supplementary Note 16]

The credit assistance method according to any one of Supplementary Notes 12 to 15, further including: calculating a score indicating suitability as a loan target from a financial indicator of a company, by using a score calculation model having learned a relationship between data of a financial indicator of a company and data indicating suitability of the company as a loan target;
outputting a list of companies of which the score satisfies a predetermined criterion; and
predicting the financial status of the first company after the first point in time, regarding a company included in the list as the first company.

[Supplementary Note 17]

The credit assistance method according to Supplementary Note 16, further including: outputting an item of a feature amount of the score calculation model used for calculation of the score and information of a weight of the feature amount; and
calculating the score by using the score calculation model reflecting the item of the feature amount and a changed value of the weight of the feature amount.

[Supplementary Note 18]

The credit assistance method according to Supplementary Note 16 or 17, further including: calculating the score by using the score calculation model according to a form of loan to the company; and
outputting the list according to the form of the loan.

[Supplementary Note 19]

The credit assistance method according to any one of Supplementary Notes 16 to 18, further including generating the score calculation model and updating the score calculation model by retraining using the data indicating suitability of the company as a loan target, the data being set based on the presence or absence of fulfillment of a loan to the company.

[Supplementary Note 20]

A program recording medium recording a credit assistance program for causing a computer to execute:
extracting a second company of which a financial indicator at a second point in time coincides with a financial indicator of a first company at a first point in time later than the second point in time under a prescribed condition; and
outputting actual data of financial status of the second company after the second point in time.

The present invention has been described using the above-described example embodiments as exemplary examples. However, the present invention is not limited to the above-described example embodiments. That is, the present invention can apply to various aspects that can be understood by those skilled in the art within the scope of the present invention.

### REFERENCE SIGNS LIST

10 Credit assistance system
11 Acquisition unit
12 Score calculation unit
13 Calculation model generation unit
14 Financial status prediction unit
15 Prediction model generation unit
16 Extraction unit
17 Output unit
18 Storage unit
20 Terminal device
100 Credit assistance system
101 Extraction unit
102 Output unit
200 Computer
201 CPU
202 Memory
203 Storage device
204 Input/output I/F
205 Communication I/F

What is claimed is:

1. A credit assistance system comprising:
at least one memory storing instructions; and
at least one processor configured to access the at least one memory and execute the instructions to:
extract a second company of which a financial indicator at a second point in time coincides with a financial indicator of a first company at a first point in time later than the second point in time under a prescribed condition; and
output actual data of financial status of the second company after the second point in time.

2. The credit assistance system according to claim 1, wherein
the at least one processor is further configured to execute the instructions to:
predict a financial status of the first company after the first point in time from the financial indicator of the first company at the first point in time by using a prediction model that has learned a relationship between data of a financial indicator of a company and data indicating a growth or deterioration status of the company; and
output the predicted financial status of the first company after the first point in time and the actual data of the financial status of the second company after the second point in time.

3. The credit assistance system according to claim 2, wherein
the at least one processor is further configured to execute the instructions to:
output a financial indicator having a higher degree of influence on a prediction result of the financial status of the first company after the first point in time than other financial indicators.

4. The credit assistance system according to claim 3, wherein
the at least one processor is further configured to execute the instructions to:
specify a first financial indicator having a higher degree of influence on the prediction result than other financial indicators and a second financial indicator having a higher degree of influence on the first financial indicator than other financial indicators; and
output the first financial indicator and the second financial indicator.

5. The credit assistance system according to claim 4, wherein
the at least one processor is further configured to execute the instructions to:
output an explanatory sentence of the prediction result based on the specified first financial indicator and the specified second financial indicator.

6. The credit assistance system according to claim 2, wherein
the at least one processor is further configured to execute the instructions to:
generate the prediction model by machine learning.

7. The credit assistance system according to claim 2, wherein
the at least one processor is further configured to execute the instructions to:
calculate a score indicating suitability as a loan target from a financial indicator of a company, by using a score calculation model having learned a relationship between data of a financial indicator of a company and data indicating suitability of the company as a loan target;
output a list of companies of which the score satisfies a predetermined criterion; and
predict the financial status of the first company after the first point in time, regarding a company included in the list as the first company.

8. The credit assistance system according to claim 7, wherein
the at least one processor is further configured to execute the instructions to:
output an item of a feature amount of the score calculation model used for calculation of the score and information of a weight of the feature amount; and
calculate the score by using the score calculation model reflecting the item of the feature amount and a changed value of the weight of the feature amount.

9. The credit assistance system according to claim 7, wherein
the at least one processor is further configured to execute the instructions to:
calculate the score by using the score calculation model according to a form of loan to the company, and
output the list according to the form of the loan.

10. The credit assistance system according to claim 7, wherein
the at least one processor is further configured to execute the instructions to:
generate the score calculation model and update the score calculation model by retraining using the data indicating suitability of the company as a loan target, the data being set based on the presence or absence of fulfillment of a loan to the company.

11. A credit assistance method comprising:
extracting a second company of which a financial indicator at a second point in time coincides with a financial indicator of a first company at a first point in time later than the second point in time under a prescribed condition; and
outputting actual data of financial status of the second company after the second point in time.

12. The credit assistance method according to claim 11, further comprising: predicting a financial status of the first company after the first point in time from the financial indicator of the first company at the first point in time by using a prediction model that has learned a relationship between data of a financial indicator of a company and data indicating a growth or deterioration status of the company; and
outputting the predicted financial status of the first company after the first point in time and the actual data of the financial status of the second company after the second point in time.

13. The credit assistance method according to claim 12, further comprising outputting a financial indicator having a higher degree of influence on a prediction result of the financial status of the first company after the first point in time than other financial indicators.

14. The credit assistance method according to claim 13, further comprising: specifying a first financial indicator having a higher degree of influence on the prediction result than other financial indicators and a second financial indicator having a higher degree of influence on the first financial indicator than other financial indicators; and
outputting the first financial indicator and the second financial indicator.

15. The credit assistance method according to claim 14, further comprising outputting an explanatory sentence of the prediction result based on the specified first financial indicator and second financial indicator.

16. The credit assistance method according to claim 12, further comprising: calculating a score indicating suitability as a loan target from a financial indicator of a company, by using a score calculation model having learned a relationship between data of a financial indicator of a company and data indicating suitability of the company as a loan target;
outputting a list of companies of which the score satisfies a predetermined criterion; and
predicting the financial status of the first company after the first point in time, regarding a company included in the list as the first company.

17. The credit assistance method according to claim 16, further comprising: outputting an item of a feature amount of the score calculation model used for calculation of the score and information of a weight of the feature amount; and
calculating the score by using the score calculation model reflecting the item of the feature amount and a changed value of the weight of the feature amount.

18. The credit assistance method according to claim 16, further comprising: calculating the score by using the score calculation model according to a form of loan to the company; and
outputting the list according to the form of the loan.

19. The credit assistance method according to claim 16, further comprising generating the score calculation model and updating the score calculation model by retraining using the data indicating suitability of the company as a loan target, the data being set based on the presence or absence of fulfillment of a loan to the company.

20. A non-transitory program recording medium recording a credit assistance program for causing a computer to execute:
extracting a second company of which a financial indicator at a second point in time coincides with a financial indicator of a first company at a first point in time later than the second point in time under a prescribed condition; and
outputting actual data of financial status of the second company after the second point in time.
